(19) United States
(12) Patent Application Publication
(10) Pub. No.: US 2026/0360739 A1
(43) Pub. Date: Nov. 12, 2026

(54) CYLINDRICAL SECONDARY BATTERY AND ELECTRONIC DEVICE

(71) Applicant: Xiamen Ampace Technology Limited, Xiamen (CN)

(72) Inventors: Chunhua LI, Xiamen (CN); Yuecheng PENG, Xiamen (CN); Xianglong HAN, Xiamen (CN)

(73) Assignee: Xiamen Ampace Technology Limited, Xiamen (CN)

(21) Appl. No.: 19/721,123

(22) Filed: Jun. 26, 2026

Related U.S. Application Data
(63) Continuation of application No. PCT/CN2023/142405, filed on Dec. 27, 2023.

(51) Int. Cl. H01M 4/587; H01M 4/02; H01M 4/70; H01M 50/107

(52) U.S. Cl. CPC H01M 4/587; H01M 4/70; H01M 50/107; H01M 2004/027

(57) ABSTRACT

A cylindrical secondary battery includes a negative electrode sheet, where the negative electrode sheet includes a negative electrode current collector and a negative electrode material layer disposed on at least one surface of the negative electrode current collector. The negative electrode material layer includes a first negative electrode material layer and a second negative electrode material layer. The first negative electrode material layer is located between the negative electrode current collector and the second negative electrode material layer, the first negative electrode material layer and the second negative electrode material layer each include a silicon-based material, and based on a mass of the negative electrode material layer, a mass percentage of element Si in the first negative electrode material layer is greater than a mass percentage of element Si in the second negative electrode material layer. The second negative electrode material layer is provided with a plurality of stripes.

### CROSS-REFERENCE TO RELATED APPLICATIONS

This application is a continuation application of International Application No. PCT/CN2023/142405, filed on Dec. 27, 2023, the contents of which are incorporated herein by reference in its entirety.

### TECHNICAL FIELD

The present application relates to the field of electrochemical technologies, and in particular to a cylindrical secondary battery and an electronic device.

### BACKGROUND

Cylindrical secondary batteries, such as cylindrical lithium-ion batteries, are applied in various high-rate discharge systems (such as systems with a discharge rate greater than 3 C), and have characteristics such as high specific energy, high operating voltage, low self-discharge rate, small volume, and light weight, and have wide applications in the field of consumer electronics.

At present, the design of high-power cylindrical lithium-ion batteries usually adopts a full tab design, that is, the positive electrode tab and the negative electrode tab extend from opposite directions, and the cylindrical lithium-ion batteries are prepared using full tab cutting and stacking or flattening technology. However, the full tab flattening structure will bring about electrode sheet infiltration problems, especially poor infiltration in the middle of the electrode sheet, which affects the performance of the lithium-ion battery. Currently, electrode sheet punching technology can be used to improve the infiltration of the electrode sheet, but the technology will cause mass loss of active material in the electrode sheet, and cause the occurrence of lithium deposition phenomenon.

### SUMMARY OF THE INVENTION

The purpose of the present application is to provide a cylindrical secondary battery and an electronic device to improve the lithium deposition performance and cycling performance of the secondary battery. The specific technical solution is as follows:

It should be noted that in the summary of the invention of the present application, the present application is explained by taking a lithium-ion battery as an example of the secondary battery, but the secondary battery of the present application is not limited to lithium-ion batteries.

A first aspect of the present application provides a cylindrical secondary battery, where the cylindrical secondary battery includes a negative electrode sheet, and the negative electrode sheet includes a negative electrode current collector and a negative electrode material layer disposed on at least one surface of the negative electrode current collector. The negative electrode material layer includes a first negative electrode material layer and a second negative electrode material layer. The first negative electrode material layer is located between the negative electrode current collector and the second negative electrode material layer, the first negative electrode material layer and the second negative electrode material layer each include a silicon-based material, and based on a mass of the negative electrode material layer, a mass percentage of element Si in the first negative electrode material layer is greater than a mass percentage of element Si in the second negative electrode material layer. The second negative electrode material layer is provided with a plurality of stripes, the plurality of stripes extend along a width direction of the unfolded negative electrode sheet, and the plurality of stripes are spaced apart along a length direction of the unfolded negative electrode sheet. By providing stripes on the second negative electrode material layer, the infiltration performance of the electrolyte on the negative electrode sheet can be improved. The content of the element Si in the second negative electrode material layer is relatively low, which helps to reduce the volume expansion of the negative electrode material layer during cycling. Meanwhile, by providing stripes on the second negative electrode material layer, the capacity loss of the negative electrode sheet is small. Further, the content of the element Si in the first negative electrode material layer is relatively high, which helps to increase the capacity of the negative electrode sheet, and thus can effectively reduce the risk of lithium deposition caused by insufficient CB value due to the provision of stripes on the second negative electrode material layer, thereby improving the cycling performance of the cylindrical secondary battery. As a result, the electrolyte exhibits good infiltration performance on the negative electrode sheet, and the cylindrical secondary battery has good lithium deposition performance and cycling performance.

In one or more embodiments of the present application, along a thickness direction of the negative electrode sheet, a thickness of the second negative electrode material layer is D μm, and a depth of a single stripe is d μm. Based on a mass of the second negative electrode material layer, a mass percentage of the element Si in the second negative electrode material layer is W, and a specific capacity of the silicon-based material is C_{Si} mAh/g, where 1.01≤W×C_{Si}×d/D≤15.87, preferably 3.20≤W×C_{Si}×d/D≤4.76; 10≤D≤55, preferably 12≤D≤45; 0.6%≤W≤5%, preferably 1%≤W≤2%; and 1300≤C_{Si}≤1800, preferably 1400≤C_{Si}≤1600. By adjusting the values of W×C_{Si}×d/D, W, C_{Si}, and D within the scope of the present application, the total amount of Si in the second negative electrode material layer is within an appropriate range. When stripes are provided on the second negative electrode material layer, the infiltration performance of the electrolyte on the negative electrode sheet can be improved. Meanwhile, the capacity loss of the negative electrode sheet is small, the volume expansion of the negative electrode material layer during cycling is relatively uniform, and the flow speed of the electrolyte in the negative electrode sheet is improved, which can effectively reduce the risk of lithium deposition caused by insufficient CB value due to the provision of stripes on the second negative electrode material layer, thereby improving the cycling performance of the cylindrical secondary battery.

In one or more embodiments of the present application, along the length direction of the unfolded negative electrode sheet, the second negative electrode material layer includes a first section, a second section, and a third section connected in sequence. Based on a length of the second negative electrode material layer, a length proportion of the first section is 10% to 30%, a length proportion of the second section is 40% to 80%, and a length proportion of the third section is 10% to 30%. The stripes on the first section have a first density, the stripes on the second section have a second density, and the stripes on the third section have a third density, the second density is greater than the first density, and the third density is less than or equal to the second density. By adjusting the magnitude relationship among the first density, the second density, and the third density, the distribution of the electrolyte in the negative electrode sheet is relatively uniform, so as to reduce the risk of lithium deposition caused by inconsistent infiltration effect of the electrolyte on the negative electrode sheet during the winding process for the preparation of the cylindrical secondary battery, improve the infiltration performance of the electrolyte on the negative electrode sheet, and improve the cycling performance of the cylindrical secondary battery.

In one or more embodiments of the present application, in the first section, the number of stripes on the second negative electrode material layer per 2 cm is 1 to 3, in the second section, the number of stripes on the second negative electrode material layer per 2 cm is 4 to 6, and in the third section, the number of stripes on the second negative electrode material layer per 2 cm is 2 to 4. By adjusting the number of stripes on the second negative electrode material layer per 2 cm in each section, that is, the values of a1, a2, and a3 within the above range, the distribution of the electrolyte in the negative electrode sheet is relatively uniform, so as to reduce the risk of lithium deposition caused by inconsistent infiltration effect of the electrolyte on the negative electrode sheet during the winding process for the preparation of the cylindrical secondary battery, improve the infiltration performance of the electrolyte on the negative electrode sheet, and improve the cycling performance of the cylindrical secondary battery.

In one or more embodiments of the present application, along the length direction of the unfolded negative electrode sheet, a width of a single stripe is n μm, where 45≤n≤85. By adjusting the width n of a single stripe within the above range, it helps to improve the infiltration performance of the electrolyte on the negative electrode sheet, and improve the penetration efficiency of the electrolyte into the negative electrode sheet. Meanwhile, the capacity loss of the negative electrode sheet is small, which helps to reduce the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance.

In one or more embodiments of the present application, along the thickness direction of the negative electrode sheet, a depth of a single stripe is d μm, where 1≤d≤30. By adjusting the depth d of a single stripe within the above range, it helps to improve the infiltration performance of the electrolyte on the negative electrode sheet and improve the penetration efficiency of the electrolyte into the negative electrode sheet. Meanwhile, it helps to reduce the risk that the second negative electrode material layer is penetrated by the stripes when the stripes are provided, and the capacity loss of the negative electrode sheet is small, thereby reducing the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance.

In one or more embodiments of the present application, based on a thickness of the negative electrode material layer, a thickness proportion of the second negative electrode material layer is T, where 40%≤T≤80%, preferably 50%≤T≤75%. By adjusting the thickness percentage proportion T of the second negative electrode material layer within the above range, when stripes are provided on the second negative electrode material layer, the risk that the second negative electrode material layer is penetrated by the stripes is reduced and the capacity loss of the negative electrode sheet is small, thereby reducing the risk of lithium deposition caused by insufficient CB value due to the provision of stripes on the second negative electrode material layer. In addition, while taking into account the capacity of the negative electrode sheet, it helps to suppress the volume expansion of the first negative electrode material layer during cycling, the volume expansion of the second negative electrode material layer provided with stripes is relatively uniform, thereby improving the cycling performance of the secondary battery.

In one or more embodiments of the present application, based on a mass of element Si in the negative electrode material layer, the mass percentage of the element Si in the second negative electrode material layer is X, where 5%≤X≤20%, preferably 8%≤X≤15%. Based on the mass of the element Si in the negative electrode material layer, by adjusting the mass percentage X of the element Si in the second negative electrode material layer within the above range, the content of the element Si in the second negative electrode material layer is low, the volume expansion of the second negative electrode material layer provided with stripes is relatively uniform, the distribution of the electrolyte in the negative electrode sheet is relatively uniform, and the flow speed of the electrolyte in the negative electrode sheet is improved, thereby improving the cycling performance of the secondary battery. Meanwhile, when stripes are provided on the second negative electrode material layer, the capacity loss of the negative electrode sheet is small, thereby reducing the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance.

A second aspect of the present application provides an electronic device, where the electronic device includes the cylindrical secondary battery according to any one of the foregoing embodiments. The cylindrical secondary battery provided by the present application has good lithium deposition performance and cycling performance. Therefore, the electronic device of the present application has a long service life.

The beneficial effects of the present application:

In some embodiments of the present application, by providing stripes on the second negative electrode material layer, the infiltration performance of the electrolyte on the negative electrode sheet can be improved. The mass percentage of the element Si in the first negative electrode material layer is greater than the mass percentage of the element Si in the second negative electrode material layer. The content of the element Si in the second negative electrode material layer is relatively low, which helps to reduce the volume expansion of the negative electrode material layer during cycling. Meanwhile, by providing stripes on the second negative electrode material layer, the capacity loss of the negative electrode sheet is small. Further, the content of the element Si in the first negative electrode material layer is relatively high, which helps to increase the capacity of the negative electrode sheet, and thus can effectively reduce the risk of lithium deposition caused by insufficient CB value due to the provision of stripes on the second negative electrode material layer, thereby improving the cycling performance of the cylindrical secondary battery. As a result, the electrolyte exhibits good infiltration performance on the negative electrode sheet, and the cylindrical secondary battery has good lithium deposition performance and cycling performance.

### BRIEF DESCRIPTION OF THE DRAWINGS

The accompanying drawings described herein are used to provide a further understanding of the present application and constitute a part of the present application. The schematic embodiments of the present application and the descriptions thereof are used to explain the present application and do not constitute an improper limitation of the present application.

FIG. 1 is a front view of a negative electrode sheet according to one embodiment of the present application;

FIG. 2 is a cross-sectional view of the negative electrode sheet in FIG. 1 along direction A-A;

FIG. 3 is a structural schematic diagram of a negative electrode sheet according to one embodiment of the present application; and

FIG. 4 is a front view of a negative electrode sheet according to another embodiment of the present application.

Reference signs in the drawings: negative electrode sheet 100; negative electrode current collector 10; negative electrode material layer 20; first negative electrode material layer 21; second negative electrode material layer 22; first section 221; second section 222; third section 223; and stripe 30.

### DETAILED DESCRIPTION

In order to make the objectives, technical solutions, and advantages of the present application clearer, the present application is further described in detail below with reference to the accompanying drawings and examples. Obviously, the described embodiments are only some embodiments of the present application, rather than all embodiments. All other embodiments obtained by those skilled in the art based on the present application fall within the protection scope of the present application.

It should be noted that in the summary of the invention of the present application, the present application is explained by taking a lithium-ion battery as an example of the secondary battery, but the secondary battery of the present application is not limited to lithium-ion batteries.

For the electrode sheet infiltration problem caused by the full tab flattening structure in cylindrical lithium-ion batteries, especially poor infiltration in the middle of the electrode sheet, which in turn affects the performance of the lithium-ion battery, the following methods are currently mainly adopted for improvement: increasing the standing time after injecting the electrolyte during the preparation of the lithium-ion battery to improve the diffusion of the electrolyte, but the production cost is increased and the initial efficiency of the lithium-ion battery is reduced. Alternatively, optimizing the electrolyte components, for example, adding dimethyl carbonate or carboxylate into the electrolyte to improve the conductivity of the electrolyte, but side reactions occur between the electrolyte and the positive electrode active material and/or negative electrode active material during cycling of the lithium-ion battery to produce excess gas, thereby easily causing safety problems. Furthermore, controlling the porosity of the positive electrode sheet and/or negative electrode sheet so that the edge porosity of the positive electrode sheet and/or negative electrode sheet is greater than the middle porosity, although the edge infiltration is improved, the infiltration effect of the middle part of the positive electrode sheet and/or negative electrode sheet is decreased, which easily leads to electrolyte discontinuity in the middle part. The inventors have found through research that providing stripes on the negative electrode sheet can effectively improve the infiltration problem of the electrolyte on the negative electrode sheet, but at the same time, the capacity of the negative electrode sheet is reduced, resulting in an insufficient local CB value and lithium deposition on the negative electrode sheet. Especially for the negative electrode sheet containing element Si, the lithium deposition problem is more prominent, thereby reducing the cycling performance of the lithium-ion battery. Therefore, the present application provides a secondary battery that can improve the infiltration performance of the electrolyte on the negative electrode sheet under the condition that the negative electrode sheet contains element Si, thereby improving the cycling performance of the secondary battery.

A first aspect of the present application provides a cylindrical secondary battery, where the cylindrical secondary battery includes a negative electrode sheet, and the negative electrode sheet includes a negative electrode current collector and a negative electrode material layer disposed on at least one surface of the negative electrode current collector. The negative electrode material layer includes a first negative electrode material layer and a second negative electrode material layer. The first negative electrode material layer is located between the negative electrode current collector and the second negative electrode material layer, the first negative electrode material layer and the second negative electrode material layer each include a silicon-based material, and based on a mass of the negative electrode material layer, a mass percentage of element Si in the first negative electrode material layer is greater than a mass percentage of element Si in the second negative electrode material layer. The second negative electrode material layer is provided with a plurality of stripes, the plurality of stripes extend along a width direction of the unfolded negative electrode sheet, and the plurality of stripes are spaced apart along a length direction of the unfolded negative electrode sheet. By providing stripes on the second negative electrode material layer, the infiltration performance of the electrolyte on the negative electrode sheet can be improved, and the penetration efficiency of the electrolyte into the negative electrode sheet can be improved. The negative electrode material layer includes a first negative electrode material layer and a second negative electrode material layer, where a mass percentage of the element Si in the first negative electrode material layer is greater than a mass percentage of the element Si in the second negative electrode material layer, and the content of the element Si in the second negative electrode material layer is relatively low, which helps to reduce the volume expansion of the negative electrode material layer during cycling. Meanwhile, by providing stripes only on the second negative electrode material layer, the capacity loss of the negative electrode sheet is small. Further, the content of the element Si in the first negative electrode material layer is relatively high, which helps to increase the capacity of the negative electrode sheet, and thus can effectively reduce the risk of lithium deposition caused by insufficient CB value due to the provision of stripes on the second negative electrode material layer, thereby improving the cycling performance of the cylindrical secondary battery. As a result, the electrolyte exhibits good infiltration performance on the negative electrode sheet, and the cylindrical secondary battery has good lithium deposition performance and cycling performance.

In the present application, the CB value refers to a ratio between the capacity of the negative electrode sheet and the capacity of the positive electrode sheet per unit area under the same state. CB=(specific capacity of negative electrode active material×mass of negative electrode active material per unit area of the negative electrode sheet×mass percentage of negative electrode active material in negative electrode material layer)/(specific capacity of positive electrode active material×mass of positive electrode active material per unit area of the positive electrode sheet×mass percentage of positive electrode active material in positive electrode material layer). The above unit area refers to 1 mm². The present application has no particular limitation on the particle size of the silicon-based material. The silicon-based material may be selected from a micron-level silicon-based material or a nano-level silicon-based material, as long as the purpose of the present application can be satisfied. For example, the average particle size of the micron-level silicon-based material may be 3 μm to 20 μm, and the average particle size of the nano-level silicon-based material may be 1 nm to 100 nm. The present application has no particular limitation on the type of silicon-based material, as long as the purpose of the present application can be achieved. For example, the micron-level silicon-based material includes but is not limited to at least one of a micron-level silicon material, a micron-level silicon-carbon material, or a micron-level silicon-oxygen material. The micron-level silicon material includes micron-level elemental silicon. The micron-level silicon-carbon material includes at least one of micron-level α-SiC (hexagonal crystal structure) or micron-level β-SiC (cubic crystal structure). The micron-level silicon-oxygen material includes at least one of micron-level SiO or micron-level SiO₂. The nano-level silicon-based material includes but is not limited to at least one of a nano-level silicon material, a nano-level silicon-carbon material, or a nano-level silicon-oxygen material. The nano-level silicon material includes nano-level elemental silicon. The nano-level silicon-carbon material includes at least one of nano-level α-SiC (hexagonal crystal structure) or nano-level β-SiC (cubic crystal structure). The nano-level silicon-oxygen material includes at least one of nano-level SiO or nano-level SiO₂.

In one embodiment of the present application, along a thickness direction of the negative electrode sheet, a thickness of the second negative electrode material layer is D μm, and a depth of a single stripe is d μm. Based on a mass of the second negative electrode material layer, a mass percentage of the element Si in the second negative electrode material layer is W, and a specific capacity of the silicon-based material is C_{Si} mAh/g, where 1.01≤W×C_{Si}×d/D≤15.87. In some embodiments, 3.20≤W×C_{Si}×d/D≤4.76. For example, the value of W×C_{Si}×d/D may be 1.01, 1.05, 1.1, 1.5, 2, 2.5, 3, 3.2, 3.5, 4, 4.5, 4.76, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 15.87, or in any range defined by any two of these values. In some embodiments, 10≤D≤55, in some other embodiments, 12≤D≤45, for example, the value of D may be 10, 12, 15, 17, 20, 22, 25, 27, 30, 32, 35, 37, 40, 42, 45, 47, 50, 52, 55, or in any range defined by any two of these values. In some embodiments, 0.6%≤W≤5%, in other embodiments, 1%≤W≤2%, for example, the value of W may be 0.6%, 0.8%, 1%, 1.2%, 1.5%, 1.7%, 2%, 2.2%, 2.5%, 2.7%, 3%, 3.2%, 3.5%, 3.7%, 4%, 4.2%, 4.5%, 4.7%, 5%, or in any range defined by any two of these values. In some embodiments, 1300≤C_{Si}≤1800, in some other embodiments, 1400≤C_{Si}≤1600, for example, the value of C_{Si} may be 1300, 1320, 1350, 1370, 1400, 1420, 1450, 1470, 1500, 1520, 1550, 1570, 1600, 1620, 1650, 1670, 1700, 1720, 1750, 1770, 1800, or in any range defined by any two of these values.

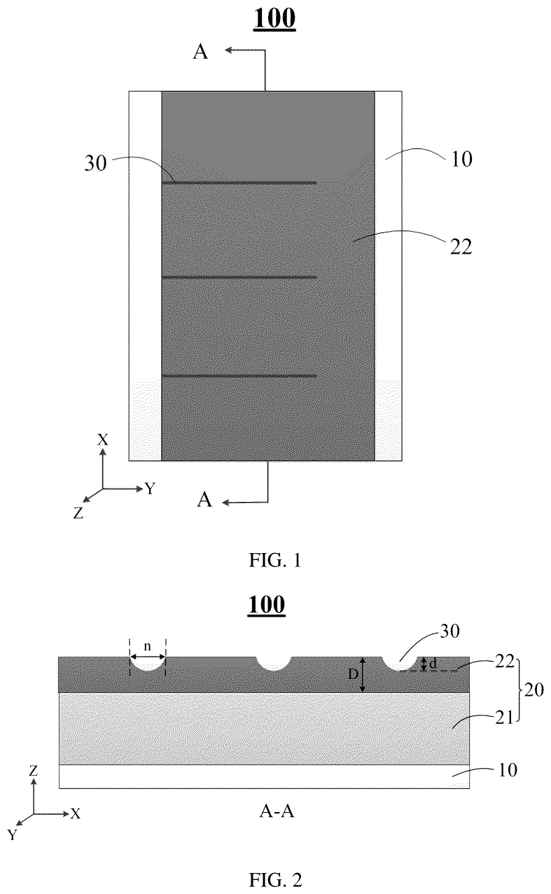

In the present application, for ease of understanding, the length direction of the negative electrode sheet in the unfolded state is defined as direction X, the width direction of the negative electrode sheet is direction Y, and the thickness direction of the negative electrode sheet is direction Z, and a three-dimensional coordinate system is established along direction X, direction Y, and direction Z. As shown in FIG. 1 and FIG. 2, the negative electrode sheet 100 in FIG. 1 is sectioned along A-A to obtain FIG. 2. Along the thickness direction (direction Z) of the negative electrode sheet 100, a thickness of the second negative electrode material layer 22 is D μm, and a depth of a single stripe 30 is d μm. By adjusting the value of W×C_{Si}×d/D within the scope of the present application, the total amount of Si in the second negative electrode material layer is within an appropriate range. When stripes are provided on the second negative electrode material layer, the infiltration performance of the electrolyte on the negative electrode sheet can be improved. Meanwhile, the capacity loss of the negative electrode sheet is small, the volume expansion of the negative electrode material layer during cycling is relatively uniform, and the flow speed of the electrolyte in the negative electrode sheet is improved, which can effectively reduce the risk of lithium deposition caused by insufficient CB value due to the provision of stripes on the second negative electrode material layer, thereby improving the cycling performance of the cylindrical secondary battery. By adjusting the thickness D of the second negative electrode material layer within the above range, it helps to reduce the risk that the second negative electrode material layer is penetrated by the stripes when the stripes are provided, and also can reduce the risk of lithium deposition caused by insufficient CB value due to the provision of stripes on the second negative electrode material layer. By adjusting the specific capacity C_{Si} of the silicon-based material within the above range, when stripes are provided on the second negative electrode material layer, the capacity loss of the negative electrode sheet is small, which helps to reduce the risk of lithium deposition caused by insufficient CB value due to the provision of stripes on the second negative electrode material layer. By adjusting the mass percentage W of the element Si in the second negative electrode material layer within the above range, when stripes are provided on the second negative electrode material layer, the capacity loss of the negative electrode sheet is small, which helps to reduce the risk of lithium deposition caused by insufficient CB value due to the provision of stripes on the second negative electrode material layer. Meanwhile, the volume expansion of the negative electrode material layer during cycling is relatively uniform, so that the flow speed of the electrolyte in the negative electrode sheet is improved. As a result, the electrolyte exhibits good infiltration performance on the negative electrode sheet, and the cylindrical secondary battery has good lithium deposition performance and cycling performance. The present application has no particular limitation on the adjustment method for adjusting the specific capacity of the silicon-based material, as long as the purpose of the present application can be achieved. For example, different types of commercially available silicon-based materials can be selected, or the average particle size of the same type of silicon-based material can be adjusted to adjust the specific capacity of the silicon-based material. The specific capacity of the silicon-based material is determined in combination with the test method of “C_{Si} test” in the present application, and a silicon-based material with the required specific capacity is selected. The present application has no particular limitation on the adjustment method for the average particle size of the silicon-based material, as long as the purpose of the present application can be achieved. For example, the adjustment can be achieved by mechanically crushing and ball milling the particles of the silicon-based material. Generally, for the same type of silicon-based material, the average particle size decreases and the specific capacity of the silicon-based material increases as the ball milling time is prolonged, the average particle size increases and the specific capacity of the silicon-based material decreases as the ball milling time is shortened. In the present application, the average particle size can be understood as the equivalent diameter. The equivalent diameter generally refers to a diameter of a sphere with the same volume as an object having an irregular shape. In the present application, a negative electrode sheet is obtained, and an area of the silicon-based material particles to be measured in the section of the negative electrode sheet is measured, and then the diameter of a circle with the same area as the measured area is used as the equivalent diameter of the particles of the silicon-based material to be measured.

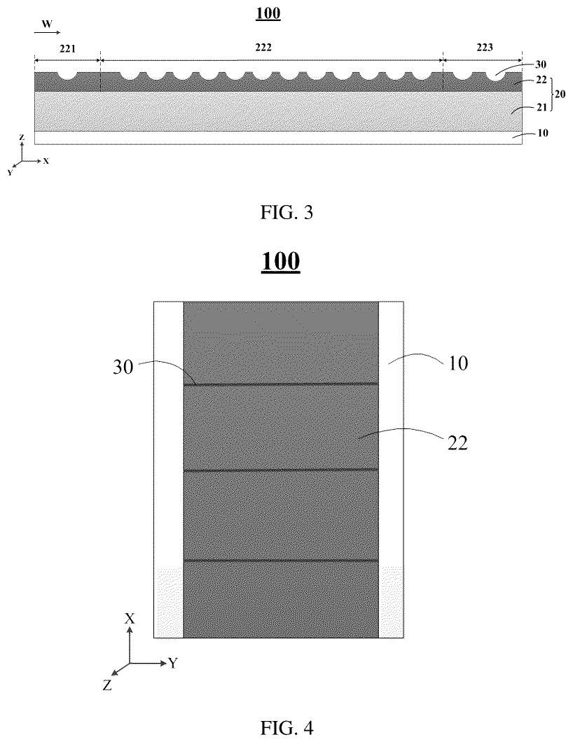

In one embodiment of the present application, as shown in FIG. 3, along the length direction (direction X) of the unfolded negative electrode sheet 100, it can be understood that the length direction (direction X) after the unfolded negative electrode sheet 100 is the same as the winding direction W of the negative electrode sheet 100 during preparation of the cylindrical secondary battery. The second negative electrode material layer 22 includes a first section 221, a second section 222, and a third section 223 connected in sequence. It can be understood that during preparation of the cylindrical secondary battery, when the electrode assembly is wound, the negative electrode sheet is wound from a position where the first section is located, and after winding is completed, the first section is located near a winding center of the electrode assembly, and the third section is located away from the winding center of the electrode assembly. Based on a length of the second negative electrode material layer 22, a length proportion of the first section 221 is 10% to 30%, a length proportion of the second section 222 is 40% to 80%, and a length proportion of the third section 223 is 10% to 30%. For example, the length proportion of the first section 221 may be 10%, 12%, 15%, 17%, 20%, 22%, 25%, 27%, 30%, or in any range defined by any two of these values, the length proportion of the second section 222 may be 40%, 42%, 45%, 47%, 50%, 52%, 55%, 57%, 60%, 62%, 65%, 67%, 70%, 72%, 75%, 77%, 80%, or in any range defined by any two of these values, and the length proportion of the third section 223 may be 10%, 12%, 15%, 17%, 20%, 22%, 25%, 27%, 30%, or in any range defined by any two of these values. The stripes 30 on the first section 221 have a first density, the stripes 30 on the second section 222 have a second density, and the stripes 30 on the third section 223 have a third density, the second density is greater than the first density, and the third density is less than or equal to the second density. By adjusting the magnitude relationship among the first density, the second density, and the third density, the distribution of the electrolyte in the negative electrode sheet is relatively uniform, so as to reduce the risk of lithium deposition caused by inconsistent infiltration effect of the electrolyte on the negative electrode sheet during the winding process for the preparation of the cylindrical secondary battery, improve the infiltration performance of the electrolyte on the negative electrode sheet, improve the infiltration efficiency of the electrolyte on the negative electrode sheet, and improve the cycling performance of the cylindrical secondary battery. As a result, the electrolyte exhibits good infiltration performance on the negative electrode sheet, and the cylindrical secondary battery has good cycling performance. In the present application, the first density refers to the number of stripes on the second negative electrode material layer per unit length in the first section, the second density refers to the number of stripes on the second negative electrode material layer per unit length in the second section, and the third density refers to the number of stripes on the second negative electrode material layer per unit length in the third section, where every 2 cm is one unit length.

In one embodiment of the present application, in the first section, the number of stripes a1 on the second negative electrode material layer per 2 cm is 1 to 3, in the second section, the number of stripes a2 on the second negative electrode material layer per 2 cm is 4 to 6, and in the third section, the number of stripes a3 on the second negative electrode material layer per 2 cm is 2 to 4. For example, in the first section, the number of stripes a1 on the second negative electrode material layer per 2 cm may be 1, 2, or 3, in the second section, the number of stripes a2 on the second negative electrode material layer per 2 cm is 4, 5, or 6, and in the third section, the number of stripes a3 on the second negative electrode material layer per 2 cm may be 2, 3, or 4. By adjusting the number of stripes on the second negative electrode material layer per 2 cm in each section, that is, the values of a1, a2, and a3 within the above range, the distribution of the electrolyte in the negative electrode sheet is relatively uniform, so as to reduce the risk of lithium deposition caused by inconsistent infiltration effect of the electrolyte on the negative electrode sheet during the winding process for the preparation of the cylindrical secondary battery, improve the infiltration performance of the electrolyte on the negative electrode sheet, improve the infiltration efficiency of the electrolyte on the negative electrode sheet, and improve the cycling performance of the cylindrical secondary battery. As a result, the electrolyte exhibits good infiltration performance on the negative electrode sheet, and the cylindrical secondary battery has good cycling performance. In the present application, the number of stripes a1, a2, and a3 on the second negative electrode material layer per 2 cm in each section are all integers.

In one embodiment of the present application, as shown in FIG. 2, along the length direction (direction X) after the negative electrode sheet 100 is unfolded, the width of a single stripe 30 is n μm, 45≤n≤85. For example, the value of n may be 45, 47, 50, 52, 55, 57, 60, 62, 65, 67, 70, 72, 75, 77, 80, 82, 85, or in any range defined by any two of these values. By adjusting the width n of a single stripe within the above range, it helps to improve the infiltration performance of the electrolyte on the negative electrode sheet and improve the penetration efficiency of the electrolyte into the negative electrode sheet. Meanwhile, the capacity loss of the negative electrode sheet is small, which helps to reduce the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance. In the present application, the cross-section of a single stripe refers to a plane formed by the length direction of the unfolded electrode assembly and the thickness direction of the stripe itself (or the section obtained by sectioning the stripe along the length direction of the unfolded electrode assembly and the thickness direction). The present application has no particular limitation on the cross-sectional shape of a single stripe, as long as the purpose of the present application can be achieved. For example, the cross-section of a single stripe may be triangular, arc-shaped (with an area less than semicircle with the same radius), semicircular, rectangular, trapezoidal, or square. In the present application, the width of a single stripe refers to the maximum dimension of a cross-section of a single stripe along the length direction of the unfolded negative electrode sheet.

In one embodiment of the present application, as shown in FIG. 2, along the thickness direction (direction Z) of the negative electrode sheet 100, a depth of a single stripe 30 is d μm, where 1≤d≤30. For example, the value of d may be 1, 2, 3, 5, 7, 10, 12, 15, 17, 20, 22, 25, 27, 30, or in any range defined by any two of these values. By adjusting the depth d of a single stripe within the above range, it helps to improve the infiltration performance of the electrolyte on the negative electrode sheet, and improve the penetration efficiency of the electrolyte into the negative electrode sheet. Meanwhile, it helps to reduce the risk that the second negative electrode material layer is penetrated by the stripes when the stripes are provided, and the capacity loss of the negative electrode sheet is small, thereby reducing the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance. Along the thickness direction of the negative electrode sheet, the depth of a single stripe is less than the thickness of the second negative electrode material layer. In the present application, the depth of a single stripe refers to a distance from a surface of the negative electrode sheet to the deepest part of a single stripe along the thickness direction of the negative electrode sheet.

In one embodiment of the present application, based on a thickness of the negative electrode material layer, a thickness proportion of the second negative electrode material layer is T, where 40%≤T≤80%. In some embodiments, 50%≤T≤75%. For example, the value of T may be 40%, 42%, 45%, 47%, 50%, 52%, 55%, 57%, 60%, 62%, 65%, 67%, 70%, 72%, 75%, 77%, 80%, or in any range defined by any two of these values. By adjusting the thickness percentage proportion T of the second negative electrode material layer within the above range, when stripes are provided on the second negative electrode material layer, the risk that the second negative electrode material layer is penetrated by the stripes is reduced and the capacity loss of the negative electrode sheet is small, thereby reducing the risk of lithium deposition caused by insufficient CB value due to the provision of stripes on the second negative electrode material layer. In addition, while taking into account the capacity of the negative electrode sheet, it helps to suppress the volume expansion of the first negative electrode material layer during cycling, the volume expansion of the second negative electrode material layer provided with stripes is relatively uniform, thereby improving the cycling performance of the secondary battery. As a result, the electrolyte exhibits good infiltration performance on the negative electrode sheet, and the cylindrical secondary battery has good lithium deposition performance and cycling performance. In the present application, the thickness percentage proportion of the second negative electrode material layer in the negative electrode material layer can be adjusted by adjusting the thickness of the first negative electrode material layer and/or the thickness of the second negative electrode material layer. In the present application, the thickness of the first negative electrode material layer and the thickness of the second negative electrode material layer can be adjusted by means known to those skilled in the art. For example, when coating the first negative electrode slurry on the surface of the negative electrode current collector, under the condition that other conditions remain unchanged and the solid content of the first negative electrode slurry is constant, the coating amount of the first negative electrode slurry is increased so as to increase the thickness of the first negative electrode material layer. The adjustment method of the thickness of the second negative electrode material layer can be understood analogously. The present application imposes no particular limitation, as long as the purpose of the present application can be achieved.

In one embodiment of the present application, based on a mass of element Si in the negative electrode material layer, a mass percentage of the element Si in the second negative electrode material layer is X, where 5%≤X≤20%. In some embodiments, 8%≤X≤15%. For example, the value of X may be 5%, 7%, 8%, 10%, 12%, 15%, 17%, 20%, or in any range defined by any two of these values. Based on the mass of the element Si in the negative electrode material layer, by adjusting the mass percentage X of the element Si in the second negative electrode material layer within the above range, the content of the element Si in the second negative electrode material layer is low, which helps to suppress the volume expansion of the first negative electrode material layer during cycling, the volume expansion of the second negative electrode material layer provided with stripes is relatively uniform, the distribution of the electrolyte in the negative electrode sheet is relatively uniform, and the flow speed of the electrolyte in the negative electrode sheet is improved, thereby improving the cycling performance of the secondary battery. Meanwhile, when stripes are provided on the second negative electrode material layer, the capacity loss of the negative electrode sheet is small, thereby reducing the risk of lithium deposition caused by insufficient CB value due to the provision of stripes on the second negative electrode material layer. As a result, the electrolyte exhibits good infiltration performance on the negative electrode sheet, and the cylindrical secondary battery has good lithium deposition performance and cycling performance.

In one embodiment of the present application, the plurality of stripes located on the second negative electrode material layer are distributed at equal intervals along the length direction of the unfolded negative electrode sheet. Through the above configuration, it helps to improve the operability of providing a plurality of stripes on the second negative electrode material layer, and helps to improve the infiltration performance of the electrolyte on the negative electrode sheet, thereby improving the cycling performance of the secondary battery while satisfying mass production manufacturability.

The present application has no particular limitation on the shape and position of the stripes, as long as the purpose of the present application can be satisfied. For example, along the width direction of the unfolded negative electrode sheet, the second negative electrode material layer has two opposite edges, and the stripes may extend from any one of the edges along the width direction of the negative electrode sheet, or the stripes may be located between the two edges. An included angle may also be formed between the stripes and the length direction of the unfolded negative electrode sheet, and the included angle is 30° to 150°. Through the above configuration, it helps to improve the infiltration performance of the electrolyte on the negative electrode sheet, thereby improving the cycling performance of the secondary battery while satisfying mass production manufacturability. The present application has no particular limitation on the length of the stripes, as long as the purpose of the present application can be satisfied. For example, along the width direction of the unfolded negative electrode sheet, based on the width of the second negative electrode material layer, the length proportion of the stripes may be 60% to 100%. When the length proportion of the stripes is 100% based on the width of the second negative electrode material layer along the width direction of the unfolded negative electrode sheet, as shown in FIG. 4, along the width direction Y of the unfolded negative electrode sheet, the length of a single stripe 30 is equal to the width of the second negative electrode material layer 22. In the present application, the features of the above embodiments can be arbitrarily combined, and some embodiments obtained by the combination are also within the protection scope of the present application.

In the present application, “negative electrode material layer disposed on at least one surface of the negative electrode current collector” means that the negative electrode material layer may be provided on one surface of the negative electrode current collector along its own thickness direction, or may be provided on two surfaces of the negative electrode current collector along its own thickness direction. It should be noted that the “surface” herein may be the entire region of the surface of the negative electrode current collector, or may be a partial region of the surface of the negative electrode current collector, and the present application imposes no particular limitation, as long as the purpose of the present application can be achieved. The present application has no particular limitation on the negative electrode current collector, as long as the purpose of the present application can be achieved. For example, the negative electrode current collector may include copper foil, copper alloy foil, nickel foil, stainless steel foil, titanium foil, foamed nickel, foamed copper, or composite current collector (such as lithium-copper composite current collector, carbon-copper composite current collector, nickel-copper composite current collector, or titanium-copper composite current collector). The present application has no particular limitation on the thickness of the negative electrode current collector, as long as the purpose of the present application can be achieved. For example, the thickness of the negative electrode current collector is 4 μm to 20 μm. The first negative electrode material layer, in addition to including the silicon-based material, further includes a first negative electrode active material, and the second negative electrode material layer, in addition to including the silicon-based material, further includes a second negative electrode active material. The present application has no particular limitation on the types of the first negative electrode active material and the second negative electrode active material, as long as the purpose of the present application can be achieved. For example, the first negative electrode active material and the second negative electrode active material may each be independently selected from at least one of natural graphite, artificial graphite, mesocarbon microbeads (MCMB), hard carbon, or soft carbon. Optionally, the first negative electrode material layer may further include a first conductive agent, a first negative electrode binder, and a first dispersant, and the second negative electrode material layer may further include a second conductive agent, a second negative electrode binder, and a second dispersant. The present application has no particular limitation on the types of the first negative electrode binder and the second negative electrode binder, as long as the purpose of the present application can be achieved. For example, the first negative electrode binder and the second negative electrode binder may include but are not limited to at least one of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyether, polymethyl methacrylate, polytetrafluoroethylene, or polyhexafluoropropylene. The present application has no particular limitation on the types of the first conductive agent and the second conductive agent, as long as the purpose of the present application can be achieved. For example, the first conductive agent and the second conductive agent may include but are not limited to at least one of conductive carbon black (Super P), carbon nanotubes (CNTs), carbon fibers, flake graphite, Ketjenblack, graphene, metal materials, or conductive polymers. The carbon nanotubes may include but are not limited to single-walled carbon nanotubes and/or multi-walled carbon nanotubes. The carbon fibers may include but are not limited to vapor-grown carbon fibers (VGCF) and/or nano carbon fibers. The metal materials may include but are not limited to metal powder and/or metal fibers, specifically, the metal may include but is not limited to at least one of copper, nickel, aluminum, or silver. The conductive polymers may include but are not limited to at least one of polyphenyl derivatives, polyaniline, polythiophene, polyacetylene, or polypyrrole. The first dispersant and the second dispersant may include but are not limited to carboxymethyl cellulose or sodium carboxymethyl cellulose.

The present application has no particular limitation on the preparation method of the negative electrode sheet, as long as the purpose of the present application can be achieved. For example, the preparation method of the negative electrode sheet includes but is not limited to the following steps: (1) uniformly mixing the mixture of the first negative electrode active material and the silicon-based material, the first negative electrode binder, the first conductive agent, and the first dispersant to obtain a first negative electrode slurry, and uniformly mixing the mixture of the second negative electrode active material and the silicon-based material, the second negative electrode binder, the second conductive agent, and the second dispersant to obtain a second negative electrode slurry; (2) coating the first negative electrode slurry on one surface of the negative electrode current collector, drying the same to obtain a negative electrode sheet coated with the first negative electrode material layer, and coating the second negative electrode slurry on the surface of the first negative electrode material layer away from the negative electrode current collector, and drying the same to obtain a negative electrode sheet coated with the first negative electrode material layer and the second negative electrode material layer on one side; (3) repeating the above operation on the other surface of the negative electrode current collector to obtain a negative electrode sheet coated with the first negative electrode material layer and the second negative electrode material layer on both sides; and (4) after cold pressing and slitting, providing stripes with corresponding numbers in sequence on the first section, second section, and third section of the second negative electrode material layer along the length direction of the negative electrode sheet, so as to obtain the negative electrode sheet.

The present application has no particular limitation on the solid content of the first negative electrode slurry and the second negative electrode slurry in the above step (1), as long as the purpose of the present application can be achieved. The present application has no particular limitation on the drying time and temperature in the above step (2), as long as the purpose of the present application can be achieved. The present application has no particular limitation on the process parameters of cold pressing in the above step (4), as long as the purpose of the present application can be achieved. The present application has no particular limitation on the method of setting stripes in the above step (4), as long as the purpose of the present application can be achieved. For example, stripes may be provided by pulse laser etching. The depth d of a single stripe and the width n of a single stripe may be adjusted by the power of the pulse laser emitter and the defocus amount, and the distance between adjacent stripes may be adjusted by adjusting the spacing between the pulse laser emitters. When the first negative electrode slurry and the second negative electrode slurry are coated on one surface of the negative electrode current collector, the stripes are provided only on one surface of the negative electrode sheet; when the first negative electrode slurry and the second negative electrode slurry are coated on two surfaces of the negative electrode current collector, the stripes are provided on two surfaces of the negative electrode sheet respectively. The present application has no particular limitation on adjusting the values of D and T, as long as the purpose of the present application can be achieved. For example, the values of D and T may be adjusted by adjusting the coating amount of the negative electrode material layer. When the coating amount of the first negative electrode material layer is constant, the value of D increases and the value of T increases as the coating amount of the second negative electrode material layer increases; and the value of D decreases and the value of T decreases as the coating amount of the second negative electrode material layer decreases. The present application has no particular limitation on adjusting the values of W and X, as long as the purpose of the present application can be achieved. For example, the values of W and X may be adjusted by adjusting the proportion of the silicon-based material in the mixture of the second negative electrode active material and the silicon-based material. When the proportion of the silicon-based material in the mixture of the first negative electrode active material and the silicon-based material is constant, the value of W increases and the value of X increases as the proportion of the silicon-based material in the mixture of the second negative electrode active material and the silicon-based material increases; and the value of W decreases and the value of X decreases as the proportion of the silicon-based material in the mixture of the second negative electrode active material and the silicon-based material decreases.

In the present application, the cylindrical secondary battery includes a positive electrode sheet. The present application has no particular limitation on the positive electrode sheet, as long as the purpose of the present application can be achieved. For example, the positive electrode sheet includes a positive electrode current collector and a positive electrode material layer disposed on at least one surface of the positive electrode current collector. The above “positive electrode material layer disposed on at least one surface of the positive electrode current collector” means that the positive electrode material layer may be provided on one surface of the positive electrode current collector along its own thickness direction, or may be provided on two surfaces of the positive electrode current collector along its own thickness direction. It should be noted that the “surface” herein may be the entire region of the surface of the positive electrode current collector, or may be a partial region of the surface of the positive electrode current collector. The present application imposes no particular limitation, as long as the purpose of the present application can be achieved. The present application has no particular limitation on the positive electrode current collector, as long as the purpose of the present application can be achieved. For example, the positive electrode current collector may include aluminum foil, aluminum alloy foil, or composite current collector (such as aluminum-carbon composite current collector). The positive electrode material layer of the present application includes a positive electrode active material, and the present application has no particular limitation on the type of the positive electrode active material, as long as the purpose of the present application can be achieved. For example, the positive electrode active material may include at least one of lithium nickel cobalt manganese oxide (NCM811, NCM622, NCM523, NCM111), lithium nickel cobalt aluminum oxide, lithium iron phosphate, lithium-rich manganese-based material, lithium cobalt oxide (LiCoO₂), lithium manganese oxide, lithium manganese iron phosphate, or lithium titanate. In the present application, the positive electrode active material may further include non-metal elements, for example, the non-metal elements include at least one of fluorine, phosphorus, boron, chlorine, silicon, or sulfur. The present application has no particular limitation on the thickness of the positive electrode current collector and the positive electrode material layer, as long as the purpose of the present application can be achieved. For example, the thickness of the positive electrode current collector is 5 μm to 20 μm, preferably 6 μm to 18 μm. The thickness of the single-sided positive electrode material layer is 30 μm to 120 μm. In the present application, the positive electrode material layer may further include a positive electrode binder and a conductive agent. The present application has no particular limitation on the type of the positive electrode binder in the positive electrode material layer, as long as the purpose of the present application can be achieved. For example, the positive electrode binder may be the same type as the negative electrode binders in the first negative electrode material layer and the second negative electrode material layer described above. The present application has no particular limitation on the type of the conductive agent in the positive electrode material layer, as long as the purpose of the present application can be achieved. For example, the conductive agent may be the same type as the conductive agents in the first negative electrode material layer and the second negative electrode material layer described above. The present application has no particular limitation on the mass ratio of the positive electrode active material, the positive electrode binder, and the conductive agent in the positive electrode material layer, and those skilled in the art can select according to actual needs, as long as the purpose of the present application can be achieved.

The present application has no particular limitation on the separator, as long as the purpose of the present application can be achieved. For example, the material of the separator may include but is not limited to at least one of polyolefins (PO) mainly composed of polyethylene (PE) and polypropylene (PP), polyester (for example, polyethylene terephthalate (PET) film), cellulose, polyimide (PI), polyamide (PA), spandex, or aramid. The type of the separator may include at least one of woven membrane, non-woven membrane, microporous membrane, composite membrane, rolled membrane, or spun membrane. The separator of the present application may have a porous structure, and the present application has no particular limitation on the pore size of the porous structure of the separator, as long as the purpose of the present application can be achieved. For example, the pore size may be 0.01 μm to 1 μm. The present application has no particular limitation on the thickness of the separator, as long as the purpose of the present application can be achieved. For example, the thickness of the separator may be 5 μm to 50 μm.

The cylindrical secondary battery of the present application includes an electrolyte, and the electrolyte includes a lithium salt and a non-aqueous solvent. The lithium salt may include at least one of LiPF₆, LiNO₃, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), lithium bis(trifluoromethanesulfonyl)imide (LiTFSI), or lithium difluoroborate. The present application does not limit the content of the lithium salt in the electrolyte, as long as the purpose of the present application can be achieved. The present application has no particular limitation on the non-aqueous solvent, as long as the purpose of the present application can be achieved. For example, the non-aqueous solvent may include but is not limited to at least one of a carbonate compound, a carboxylate compound, an ether compound, or other organic solvents. The carbonate compound may include but is not limited to at least one of a chain carbonate compound, a cyclic carbonate compound, or a fluorinated carbonate compound. The chain carbonate compound may include but is not limited to at least one of dimethyl carbonate, diethyl carbonate, dipropyl carbonate, methyl propyl carbonate, ethyl propyl carbonate, or methyl ethyl carbonate. The cyclic carbonates may include but are not limited to at least one of ethylene carbonate, propylene carbonate (PC), butylene carbonate, or vinylene ethylene carbonate. The fluorinated carbonate compound may include but is not limited to at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. The other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The cylindrical secondary battery of the present application further includes a housing for accommodating the positive electrode sheet, the negative electrode sheet, the separator, the electrolyte, and other components known in the art in the cylindrical secondary battery. The present application imposes no limitation on the above other components. The present application has no particular limitation on the housing, and the housing may be a housing known in the art, as long as the purpose of the present application can be achieved.

The cylindrical secondary battery of the present application has no particular limitation, and may include any device in which an electrochemical reaction occurs. In one embodiment of the present application, the cylindrical secondary battery may include, but is not limited to, lithium-ion secondary battery (lithium-ion battery), lithium polymer secondary battery, or lithium-ion polymer secondary battery.

The present application has no particular limitation on the preparation method of the cylindrical secondary battery, and a preparation method known in the art may be selected, as long as the purpose of the present application can be achieved. For example, the preparation method of the cylindrical secondary battery includes but is not limited to the following steps: stacking the separator, the positive electrode sheet, the separator, and the negative electrode sheet in sequence, and performing operations such as winding and folding as needed to obtain an electrode assembly with a wound structure, placing the electrode assembly into the housing, injecting the electrolyte into the housing, and performing sealing to obtain the cylindrical secondary battery.

A second aspect of the present application provides an electronic device, where the electronic device includes the cylindrical secondary battery according to any one of the foregoing embodiments. The cylindrical secondary battery provided by the present application has good lithium deposition performance and cycling performance. Therefore, the electronic device of the present application has a long service life.

The electronic device of the present application is not particularly limited, and may be any electronic device known in the prior art. For example, the electronic device may include but is not limited to a notebook computer, a pen-input computer, a mobile computer, an e-book player, a portable phone, a portable fax machine, a portable copier, a portable printer, a stereo headphone, a video recorder, a liquid crystal television, a portable cleaner, a portable CD player, a mini disc, a transceiver, an electronic organizer, a calculator, a memory card, a portable recorder, a radio, a backup power source, a motor, an automobile, a motorcycle, an electric bicycle, a bicycle, a lighting fixture a toy, a game console, a clock, a power tool, a flashlight, a camera, a household large-scale storage battery, and a lithium-ion capacitor.

### EXAMPLES

Hereinafter, examples and comparative examples are given to more specifically illustrate some embodiments of the present application. Various tests and evaluations were carried out according to the following methods. In addition, unless otherwise specified, “parts” and “%” were on a mass basis.

### Test Methods and Equipment:

At an ambient temperature of 25 °C, the lithium-ion battery was disassembled, the negative electrode sheet was taken out and soaked in dimethyl carbonate (DMC) for 20 min, and then the negative electrode sheet was placed in an oven and dried at 80 °C for 12 h to obtain a negative electrode sheet sample. The negative electrode sheet samples used in the following test for C_{Si}, test for the average particle size test of silicon-based material particles, and tests for D, d, T, W, X, and n were all obtained by the above method.

### Test for C_{Si}:

The negative electrode sheet to be tested was weighed to obtain the mass M of the negative electrode sheet, and a copper foil of the same area size was weighed to obtain the mass m of the negative electrode current collector copper foil, and the mass of the negative electrode material layer to be tested was M−m. The negative electrode sheet to be tested was used as the working electrode, the lithium sheet was used as the counter electrode, the separator was placed between the negative electrode sheet to be tested and the lithium sheet for isolation. The electrolyte was injected, and a button cell was assembled. A Land battery test system was used for testing, and the voltage, capacity, and current of the button cell during the test were recorded: (1) rested for 3 h; (2) discharged at 0.05 C DC to 0.005 V, and discharged at 50 μA DC to 0.005 V again; (3) rested for 5 min; (4) charged at 0.05 C constant current to 2 V; (5) rested for 5 min; (6) cycling steps (2) to (5) were repeated 2 cycles (cls); and test ended. The capacity after the end of the second cycle was taken as the capacity C₀ of the button cell. The specific capacity of the negative electrode material layer to be tested was calculated, and the specific capacity of the negative electrode material layer to be tested was calculated as C₀/(M−m). The separator and electrolyte used in the test were the same as those in Example 1-1.

A section of the negative electrode sheet 100 along A-A as shown in FIG. 1 was prepared subjected to ion polishing treatment to obtain the section of the negative electrode sheet 100 as shown in FIG. 2. A scanning electron microscope was used to observe the section of the negative electrode sheet 100, and then the silicon-based material particles and graphite particles in the negative electrode material layer 20 in the section of the negative electrode sheet 100 were distinguished and counted through backscattering mode, so as to obtain the proportion a1 of graphite particles in the negative electrode material layer 20 and the proportion b1 of silicon-based material in the negative electrode material layer 20. Silicon-based material had a higher atomic number and higher electron density, and the interaction between the silicon-based material and the test electron beam was stronger than the interaction between the graphite particles and the test electron beam, so the silicon-based material region appeared brighter, while the graphite particle region appeared darker accordingly. An X-ray energy spectrometer (EDS) was used to perform elemental analysis test on the negative electrode material layer 20 in the section of the negative electrode sheet 100. The X-ray energy spectrometer (EDS) was used to distinguish C materials and Si materials, to determine the proportion a2 of graphite particles in the negative electrode material layer 20 and the proportion b2 of silicon-based material in the negative electrode material layer 20. The proportion a of graphite particles in the negative electrode material layer 20 was (a1+a2)/2, and the proportion b of silicon-based material in the negative electrode material layer 20 was (b1+b2)/2. According to the specific capacity C₀/(M−m) of the negative electrode material layer 20 to be tested, the proportion of silicon-based material in the negative electrode material layer 20, and the specific capacity of graphite particles (360 mAh/g), the specific capacity C_{Si} of the silicon-based material was obtained by the formula: C_{Si}=C₀/(M−m)−360a/b.

### Average Particle Size Test of Silicon-Based Material:

A scanning electron microscope (SEM) was used to test the average particle size of the silicon-based material. The section of the negative electrode sheet 100 prepared as in FIG. 1 along A-A was subjected to ion polishing treatment to obtain the section of the negative electrode sheet 100 as in FIG. 2. A scanning electron microscope was used to observe the section of the negative electrode sheet 100, and then the silicon-based material particles and graphite particles in the negative electrode material layer 20 in the section of the negative electrode sheet 100 were distinguished through backscattering mode. 32 silicon-based material particles were randomly selected for equivalent diameter measurement, and the average value was the average particle size of the silicon-based material measured. In the present application, the average particle size can be understood as the equivalent diameter, and the equivalent diameter generally refers to the diameter of a sphere having the same volume as an object with an irregular shape. The area of the silicon-based material particles to be measured in the section of the negative electrode sheet was measured, and then the diameter of a circle with the same area as the area was used as the equivalent diameter of the particles of the silicon-based material to be measured.

### Tests for D, d, T, W, X, and n:

The section of the negative electrode sheet 100 prepared as in FIG. 1 along A-A was subjected to ion polishing treatment to obtain the section of the negative electrode sheet 100 as in FIG. 2. A scanning electron microscope was used to observe the section of the negative electrode sheet 100, and a clear double-layer coating boundary line, the boundary line between the first negative electrode material layer 21 and the negative electrode current collector 10, and the cross-sectional shape of the stripe 30 could be observed. The maximum length between the cross-sections of a single stripe 30 along the length direction after the negative electrode sheet 100 is unfolded was measured, which is the width n of a single stripe 30. The positions of the first negative electrode material layer 21, the second negative electrode material layer 22, and the negative electrode current collector 10 were determined by the two boundary lines. Along the thickness direction (direction Z) of the negative electrode sheet 100, the distance from the surface of the negative electrode sheet 100 to the double-layer coating boundary line was measured, which is the thickness D of the second negative electrode material layer 22, the distance from the surface of the negative electrode sheet 100 to the deepest part of a single stripe 30 is the depth d of a single stripe 30, the distance from the surface of the negative electrode sheet 100 to the boundary line between the negative electrode material layer 20 and the negative electrode current collector 10 is the thickness of the negative electrode material layer 20, and the thickness D of the second negative electrode material layer 22 divided by the thickness of the negative electrode material layer 20 is the thickness proportion T of the second negative electrode material layer 22.

An X-ray energy spectrometer (EDS) was used to perform elemental analysis tests on the negative electrode material layer 20, the first negative electrode material layer 21, and the second negative electrode material layer 22 in the section of the negative electrode sheet 100 respectively, and the mass percentage W of the element Si in the second negative electrode material layer 22 based on the mass of the second negative electrode material layer 22 was calculated, as well as the mass percentage X of the element Si in the second negative electrode material layer 22 based on the mass of the element Si in the negative electrode material layer 20.

### Lithium Deposition Performance Test:

The lithium-ion batteries in the examples and comparative examples were placed in a thermostat at 10 °C, stood for 60 minutes, then charged at 2 C constant current to 4.2 V, charged at 4.2 V constant voltage to a current of 0.05 C, stood for 5 minutes, and then discharged at 0.5 C constant current to 2.5 V, which is one cycle. After cycling 10 cycles according to the above charging and discharging process and then charged at 2 C constant current to 4.2 V, the lithium-ion battery was disassembled, and the lithium deposition state on the surface of the negative electrode sheet was observed. The area without lithium deposition on the surface of the negative electrode sheet was golden yellow, and the lithium deposition area was grayish white.

The judgment standard for the degree of lithium deposition in the lithium-ion battery is as follows: lithium deposition area of 0% is no lithium deposition, lithium deposition area greater than 0 and less than or equal to 2% is mild lithium deposition, lithium deposition area greater than 2% and less than or equal to 20% is moderate lithium deposition, lithium deposition area greater than 20% and less than or equal to 100% is severe lithium deposition, wherein the percentage of the lithium deposition area is calculated based on the total area of the negative electrode material layer.

### Cycling Performance Test:

The lithium-ion batteries in the examples and comparative examples were subjected to charge-discharge cycle tests in a thermostat at 25 °C. The lithium-ion battery was charged at 2 C constant current to 4.2 V, charged at 4.2 V constant voltage to 0.05 C, stood for 5 minutes, and then discharged at 6 C constant current to 2.5 V, which was the first cycle, and the first cycle discharge capacity C₁ was recorded. After cycling 600 cycles according to the above cycle process, the discharge capacity C₆₀₀ of the lithium-ion battery was recorded, and the 600th cycle capacity retention rate was calculated as an indicator to evaluate the infiltration effect of the negative electrode sheet and the cycling performance of the lithium-ion battery, as shown in formula (I). When the 600 cycles (cls) capacity retention rate is lower, it indicates that the infiltration effect of the negative electrode sheet in the lithium-ion battery is worse, and the cycling performance of the lithium-ion battery is worse; when the 600 cls capacity retention rate is higher, it indicates that the infiltration effect of the negative electrode sheet in the lithium-ion battery is better, and the cycling performance of the lithium-ion battery is better.

600 cls capacity retention rate (%)=C₆₀₀/C₁×100%. (I)

### Example 1-1

### <Preparation of Negative Electrode Sheet>

A mixture of the first negative electrode active material natural graphite and the silicon-based material nano-level SiO, the first dispersant sodium carboxymethyl cellulose, and the first negative electrode binder styrene-butadiene rubber were mixed at a mass ratio of 97.3:1.7:1.0. Deionized water was added as a solvent, and the mixture was stirred and mixed uniformly to obtain a first negative electrode slurry with a solid content of 50 wt %. A mixture of the second negative electrode active material natural graphite and the silicon-based material nano-level SiO, the second dispersant sodium carboxymethyl cellulose, and the second negative electrode binder styrene-butadiene rubber were mixed at a mass ratio of 97.3:1.7:1.0. Deionized water was added as a solvent, and the mixture was stirred and mixed uniformly to obtain a second negative electrode slurry with a solid content of 50 wt %. The first negative electrode slurry was uniformly coated on one surface of the negative electrode current collector copper foil and dried at 105 °C, and the second negative electrode slurry was uniformly coated on the surface of the first negative electrode material layer away from the negative electrode current collector copper foil and dried at 105 °C. A negative electrode sheet coated with the first negative electrode material layer and the second negative electrode material layer on one side was obtained. The above steps were repeated on the other surface of the negative electrode current collector copper foil to obtain a negative electrode sheet coated with the first negative electrode material layer and the second negative electrode material layer on both sides. After cold pressing and slitting, the tail end of the second negative electrode material layer for making the cylindrical lithium-ion battery was determined.

Starting from the tail end of the second negative electrode material layer, along the length direction of the negative electrode sheet, the first section, second section, and third section of the second negative electrode material layer were determined. Based on a length of the second negative electrode material layer, a length proportion of the first section was 30%, a length proportion of the second section was 40%, and a length proportion of the third section was 30%. In the first section, the number of stripes a1 on the second negative electrode material layer per 2 cm was 2; in the second section, the number of stripes a2 on the second negative electrode material layer per 2 cm was 5; and in the third section, the number of stripes a3 on the second negative electrode material layer per 2 cm was 3.

As shown in FIG. 2, cross-sectional observation was conducted along the length direction (direction X) and thickness direction (direction Z) of the unfolded negative electrode sheet 100. The cross-sectional shape of a single stripe 30 was arc-shaped, the depth d of a single stripe 30 was 5.33 μm, and the width n of a single stripe 30 was 65 μm. According to the above data, laser-etched stripes were formed on the first section, second section, and third section of the two surfaces of the second negative electrode material layer of the negative electrode sheet to obtain a negative electrode sheet with dimensions of 62 mm×1464 mm. Based on the mass of the first negative electrode material layer, the mass percentage of the element Si was 5.8%; based on the mass of the second negative electrode material layer, the mass percentage W of the element Si was 0.8%, based on the mass of the element Si in the negative electrode material layer, the mass percentage X of the element Si in the second negative electrode material layer was 12%, the specific capacity C_{Si} of the silicon-based material nano-level SiO was 1500 mAh/g, the average particle size of the silicon-based material nano-level SiO was 75 nm, the ball milling time was 6 h, the thickness D of the second negative electrode material layer was 20 μm, and based on the thickness of the negative electrode material layer, the thickness proportion T of the second negative electrode material layer was 60%.

### <Preparation of Positive Electrode Sheet>

A positive electrode active material lithium nickel cobalt manganese oxide (LiNi_{0.8}Co_{0.1}Mn_{0.1}O₂), a binder polyvinylidene fluoride (PVDF), and conductive carbon black were dispersed in N-methylpyrrolidone (NMP) solvent at a mass ratio of 94.8:2.8:2.4. The mixture was fully stirred and mixed to obtain a positive electrode slurry with a solid content of 72 wt %. The positive electrode slurry was uniformly coated on one surface of a positive electrode current collector aluminum foil with a thickness of 13 μm and dried at 105 °C to obtain a positive electrode sheet coated with the positive electrode material layer on one side. The above steps were repeated on the other surface of the positive electrode current collector aluminum foil to obtain a positive electrode sheet coated with the positive electrode material layer on both sides. After cold pressing, cutting, and slitting, the sheet was dried for 4 h under vacuum at 105 °C to obtain a positive electrode sheet with dimensions of 60.3 mm×1400 mm for later use. The coating weight of the positive electrode material layer was 12 mg/cm², and the compaction density of the positive electrode material layer was 3.4 g/cm³.

### <Preparation of Separator>

A polyethylene (PE) film with a thickness of 12 μm was used as the separator.

### <Preparation of Electrolyte>

In a dry argon atmosphere glove box, the organic solvents ethylene carbonate (EC), methyl ethyl carbonate (EMC), and diethyl carbonate (DEC) were mixed at a mass ratio of 30:50:20. Lithium salt lithium hexafluorophosphate (LiPF₆) was added to the above organic solvent, and the mixture was fully mixed uniformly to obtain the electrolyte. Based on the mass of the electrolyte, the mass percentage of LiPF₆ was 12.5%.

### <Preparation of Lithium-Ion Battery>

The separator, positive electrode sheet, separator, and negative electrode sheet prepared above were stacked in sequence so that the separator was placed between the positive electrode and the negative electrode for isolation. After winding, flattening, current collecting plate welding, casing, code spraying, vacuum drying, electrolyte injection, crimping, and high-temperature standing, formation and capacity grading were performed to obtain a cylindrical lithium-ion battery. During winding, winding was started from the position where the first section was located. After winding was completed, the first section was located near the winding center of the electrode assembly, and the third section was located away from the winding center of the electrode assembly. The upper limit formation voltage was 3.6 V, the formation temperature was 45 °C, and the formation standing time was 2 h.

### Examples 1-2 to 1-28

Except that the preparation parameters were adjusted according to Table 1, the rest were the same as in Example 1-1. When D and W were changed, the coating amount of the first negative electrode material layer, the coating amount of the second negative electrode material layer, the ratio of the silicon-based material in the mixture of the first negative electrode active material and the silicon-based material, and the ratio of the silicon-based material in the mixture of the second negative electrode active material and the silicon-based material were adjusted so that the values of D and W matched the values shown in Table 1.

### Examples 1-29 to 1-34

Except that the preparation parameters were adjusted according to Table 1, the rest were the same as in Example 1-14. When the average particle size of the silicon-based material particles was changed, the ball milling time was adjusted so that the average particle size of the silicon-based material particles matched the value shown in Table 1.

### Example 1-35

Except that the silicon-based material nano-level SiO was replaced with micron-level SiO and the preparation parameters were adjusted according to Table 1, the rest were the same as in Example 1-14. The average particle size of the micron-level SiO was 12 μm, that is, 12000 nm.

### Example 1-36

Except that the silicon-based material nano-level SiO was replaced with nano-level Si and the relevant parameters were adjusted according to Table 1, the rest were the same as in Example 1-34.

### Examples 1-37 to 1-53

Except that the preparation parameters were adjusted according to Table 1, the rest were the same as in Example 1-1. When T and X were changed, the coating amount of the first negative electrode material layer, the coating amount of the second negative electrode material layer, the ratio of the silicon-based material in the mixture of the first negative electrode active material and the silicon-based material, and the ratio of the silicon-based material in the mixture of the second negative electrode active material and the silicon-based material were adjusted so that the values of T and X matched the values shown in Table 1. When the average particle size of the silicon-based material particles was changed, the ball milling time was adjusted so that the average particle size of the silicon-based material particles matched the value shown in Table 1.

### Examples 2-1 to 2-8

Except that the preparation parameters were adjusted according to Table 2, the rest were the same as in Example 1-1.

### Comparative Example 1

Except that no stripes were provided on the second negative electrode material layer, the rest were the same as in Example 1-1.

### Comparative Example 2

Except that the negative electrode sheet was prepared by the following steps, the rest were the same as in Example 1-1.

### <Preparation of Negative Electrode Sheet>

A mixture of the negative electrode active material natural graphite and the silicon-based material nano-level SiO, a dispersant sodium carboxymethyl cellulose, and a negative electrode binder styrene-butadiene rubber were mixed at a mass ratio of 97.3:1.7:1.0. Deionized water was added as a solvent, and the mixture was stirred and mixed uniformly to obtain a negative electrode slurry with a solid content of 50 wt %. The negative electrode slurry was uniformly coated on one surface of the negative electrode current collector copper foil and dried at 105 °C to obtain a negative electrode sheet coated with the negative electrode material layer on one side. Then, the above steps were repeated on the other surface of the negative electrode current collector copper foil to obtain a negative electrode sheet coated with the negative electrode material layer on both sides. After cold pressing and slitting, laser-etched stripes were formed on the two negative electrode material layer surfaces of the negative electrode sheet along the length direction of the negative electrode sheet. The number of stripes on the negative electrode material layer per 2 cm was 2. A negative electrode sheet with dimensions of 62 mm×1464 mm was obtained. The cross-sectional shape of a single stripe was arc-shaped. Along the thickness direction of the negative electrode sheet, the depth d of a single stripe was 5.33 μm, along the length direction after the negative electrode sheet was unfolded, the width n of a single stripe was 65 μm, based on the mass of the negative electrode material layer, the mass percentage of the element Si was 5.8%, the specific capacity C_{Si} of the silicon-based material nano-level SiO was 1500 mAh/g, the average particle size of the silicon-based material nano-level SiO was 75 nm, and the thickness of the negative electrode material layer was 33.3 μm.

### Comparative Example 3

Except that the negative electrode sheet was prepared by the following steps, the rest were the same as in Example 1-1.

### <Preparation of Negative Electrode Sheet>

A mixture of the negative electrode active material natural graphite and the silicon-based material nano-level SiO, a dispersant sodium carboxymethyl cellulose, and a negative electrode binder styrene-butadiene rubber were mixed at a mass ratio of 97.3:1.7:1.0. Deionized water was added as a solvent, and the mixture was stirred and mixed uniformly to obtain a negative electrode slurry with a solid content of 50 wt %. The negative electrode slurry was uniformly coated on one surface of the negative electrode current collector copper foil and dried at 105 °C to obtain a negative electrode sheet coated with the negative electrode material layer on one side. The above steps were repeated on the other surface of the negative electrode current collector copper foil to obtain a negative electrode sheet coated with the negative electrode material layer on both sides. After cold pressing and slitting, laser-etched stripes were formed on the two negative electrode material layer surfaces of the negative electrode sheet along the length direction of the negative electrode sheet. The number of stripes on the negative electrode material layer per 2 cm was 2. A negative electrode sheet with dimensions of 62 mm×1464 mm was obtained. The cross-sectional shape of a single stripe was arc-shaped. Along the thickness direction of the negative electrode sheet, the depth d of a single stripe was 5.33 μm, along the length direction after the negative electrode sheet was unfolded, the width n of a single stripe was 65 μm, based on the mass of the negative electrode material layer, the mass percentage of the element Si was 0.8%, the specific capacity C_{Si} of the silicon-based material nano-level SiO was 1500 mAh/g, the average particle size of the silicon-based material nano-level SiO was 75 nm, and the thickness of the negative electrode material layer was 33.3 μm.

### Comparative Example 4

Except that the negative electrode sheet was prepared by the following steps, the rest were the same as in Example 1-1.

### <Preparation of Negative Electrode Sheet>

A mixture of the negative electrode active material natural graphite and the silicon-based material nano-level SiO, a dispersant sodium carboxymethyl cellulose, and a negative electrode binder styrene-butadiene rubber were mixed at a mass ratio of 97.3:1.7:1.0. Deionized water was added as a solvent, and the mixture was stirred and mixed uniformly to obtain a negative electrode slurry with a solid content of 50 wt %. The negative electrode slurry was uniformly coated on one surface of the negative electrode current collector copper foil and dried at 105 °C to obtain a negative electrode sheet coated with the negative electrode material layer on one side. The above steps were repeated on the other surface of the negative electrode current collector copper foil to obtain a negative electrode sheet coated with the negative electrode material layer on both sides. After cold pressing and slitting, a negative electrode sheet with dimensions of 62 mm×1464 mm was obtained. Based on the mass of the negative electrode material layer, the mass percentage of the element Si was 5.8%, the specific capacity C_{Si} of the silicon-based material nano-level SiO was 1500 mAh/g, the average particle size of the silicon-based material nano-level SiO was 75 nm, and the thickness of the negative electrode material layer was 33.3 μm.

### Comparative Example 5

Except that the positions of the first negative electrode material layer and the second negative electrode material layer were swapped, the rest were the same as in Example 1-1.

The preparation parameters and performance parameters of examples and comparative examples are shown in Tables 1 to 2.

TABLE 1

| | | | | | Average | | | | | |
|---|---|---|---|---|---|---|---|---|---|---|
| | | | | | particle size | | | | | Capacity |
| | | | | | of silicon- | | | | | retention |
| | | | | | based material | | | | Degree of | rate after |
| | | D | W | C_{Si} | particles | d | T | X | lithium | 600 cls |
| | W × C_{Si} × d/D | (μm) | (%) | (mAh/g) | (nm) | (μm) | (%) | (%) | deposition | (%) |
| Example 1-1 | 3.2 | 20 | 0.8 | 1500 | 75 | 5.33 | 60 | 12 | No lithium | 85.5 |
| | | | | | | | | | deposition | |
| Example 1-2 | 1.01 | 20 | 0.8 | 1500 | 75 | 1.68 | 60 | 12 | Mild lithium | 81.0 |
| | | | | | | | | | deposition | |
| Example 1-3 | 2.5 | 20 | 0.8 | 1500 | 75 | 4.17 | 60 | 12 | Mild lithium | 83.0 |
| | | | | | | | | | deposition | |
| Example 1-4 | 3.8 | 20 | 0.8 | 1500 | 75 | 6.33 | 60 | 12 | No lithium | 86.0 |
| | | | | | | | | | deposition | |
| Example 1-5 | 4.2 | 20 | 0.8 | 1500 | 75 | 7 | 60 | 12 | No lithium | 86.5 |
| | | | | | | | | | deposition | |
| Example 1-6 | 4.76 | 20 | 0.8 | 1500 | 75 | 7.93 | 60 | 12 | No lithium | 87.0 |
| | | | | | | | | | deposition | |
| Example 1-7 | 10 | 20 | 0.8 | 1500 | 75 | 16.67 | 60 | 12 | Mild lithium | 83.5 |
| | | | | | | | | | deposition | |
| Example 1-8 | 15.87 | 30 | 1.2 | 1500 | 75 | 26.45 | 60 | 12 | Mild lithium | 84.0 |
| | | | | | | | | | deposition | |
| Example 1-9 | 0.5 | 20 | 0.8 | 1500 | 75 | 0.83 | 60 | 12 | Mild lithium | 76.1 |
| | | | | | | | | | deposition | |
| Example 1-10 | 17 | 30 | 1.2 | 1500 | 75 | 28.33 | 60 | 30 | Mild lithium | 75.5 |
| | | | | | | | | | deposition | |
| Example 1-11 | 3.2 | 10 | 0.8 | 1500 | 75 | 2.67 | 60 | 12 | Mild lithium | 80.2 |
| | | | | | | | | | deposition | |
| Example 1-12 | 3.2 | 11 | 0.8 | 1500 | 75 | 2.93 | 60 | 12 | Mild lithium | 80.5 |
| | | | | | | | | | deposition | |
| Example 1-13 | 3.2 | 12 | 0.8 | 1500 | 75 | 3.2 | 60 | 12 | No lithium | 81.1 |
| | | | | | | | | | deposition | |
| Example 1-14 | 3.2 | 30 | 0.8 | 1500 | 75 | 8 | 60 | 12 | No lithium | 82.5 |
| | | | | | | | | | deposition | |
| Example 1-15 | 3.2 | 45 | 0.8 | 1500 | 75 | 12 | 60 | 12 | No lithium | 83.0 |
| | | | | | | | | | deposition | |
| Example 1-16 | 3.2 | 50 | 0.8 | 1500 | 75 | 13.33 | 60 | 12 | Mild lithium | 79.5 |
| | | | | | | | | | deposition | |
| Example 1-17 | 3.2 | 55 | 0.8 | 1500 | 75 | 14.67 | 60 | 12 | Mild lithium | 79.3 |
| | | | | | | | | | deposition | |
| Example 1-18 | 3.2 | 6 | 0.8 | 1500 | 75 | 1.6 | 60 | 12 | Mild lithium | 75 |
| | | | | | | | | | deposition | |
| Example 1-19 | 3.2 | 8 | 0.8 | 1500 | 75 | 2.13 | 60 | 12 | Mild lithium | 75.6 |
| | | | | | | | | | deposition | |
| Example 1-20 | 3.2 | 80 | 0.8 | 1500 | 75 | 21.33 | 60 | 12 | Mild lithium | 74.7 |
| | | | | | | | | | deposition | |
| Example 1-21 | 3.2 | 30 | 0.6 | 1500 | 75 | 10.67 | 60 | 12 | Mild lithium | 78.5 |
| | | | | | | | | | deposition | |
| Example 1-22 | 3.2 | 30 | 1 | 1500 | 75 | 6.4 | 60 | 12 | No lithium | 83.5 |
| | | | | | | | | | deposition | |
| Example 1-23 | 3.2 | 30 | 1.5 | 1500 | 75 | 4.27 | 60 | 12 | No lithium | 84.0 |
| | | | | | | | | | deposition | |
| Example 1-24 | 3.2 | 30 | 2 | 1500 | 75 | 3.2 | 60 | 12 | No lithium | 84.5 |
| | | | | | | | | | deposition | |
| Example 1-25 | 3.2 | 30 | 3 | 1500 | 75 | 2.13 | 60 | 12 | Mild lithium | 77.5 |
| | | | | | | | | | deposition | |
| Example 1-26 | 3.2 | 30 | 5 | 1500 | 75 | 1.28 | 60 | 12 | Mild lithium | 78.2 |
| | | | | | | | | | deposition | |
| Example 1-27 | 1.01 | 30 | 0.1 | 1500 | 75 | 20.2 | 60 | 12 | Mild lithium | 70.1 |
| | | | | | | | | | deposition | |
| Example 1-28 | 3.2 | 30 | 10 | 1500 | 75 | 0.64 | 60 | 12 | Mild lithium | 69.2 |
| | | | | | | | | | deposition | |
| Example 1-29 | 3.2 | 30 | 0.8 | 1300 | 100 | 9.23 | 60 | 12 | Mild lithium | 78.0 |
| | | | | | | | | | deposition | |
| Example 1-30 | 3.2 | 30 | 0.8 | 1350 | 90 | 8.89 | 60 | 12 | Mild lithium | 79.5 |
| | | | | | | | | | deposition | |
| Example 1-31 | 3.2 | 30 | 0.8 | 1400 | 80 | 8.57 | 60 | 12 | No lithium | 82.1 |
| | | | | | | | | | deposition | |
| Example 1-32 | 3.2 | 30 | 0.8 | 1600 | 70 | 7.5 | 60 | 12 | No lithium | 83.0 |
| | | | | | | | | | deposition | |
| Example 1-33 | 3.2 | 30 | 0.8 | 1700 | 60 | 7.06 | 60 | 12 | Mild lithium | 78.2 |
| | | | | | | | | | deposition | |
| Example 1-34 | 3.2 | 30 | 0.8 | 1800 | 50 | 6.67 | 60 | 12 | Mild lithium | 79.1 |
| | | | | | | | | | deposition | |
| Example 1-35 | 3.2 | 30 | 0.8 | 800 | 12000 | 15 | 60 | 12 | Mild lithium | 72.1 |
| | | | | | | | | | deposition | |
| Example 1-36 | 3.2 | 30 | 0.8 | 4200 | 50 | 2.86 | 60 | 12 | Mild lithium | 74.3 |
| | | | | | | | | | deposition | |
| Example 1-37 | 3.2 | 20 | 0.8 | 1500 | 75 | 5.33 | 40 | 12 | Mild lithium | 80.2 |
| | | | | | | | | | deposition | |
| Example 1-38 | 3.2 | 20 | 0.8 | 1500 | 75 | 5.33 | 45 | 12 | Mild lithium | 81.3 |
| | | | | | | | | | deposition | |
| Example 1-39 | 3.2 | 20 | 0.8 | 1500 | 75 | 5.33 | 50 | 12 | No lithium | 84.6 |
| | | | | | | | | | deposition | |
| Example 1-40 | 3.2 | 20 | 0.8 | 1500 | 75 | 5.33 | 75 | 12 | No lithium | 86.5 |
| | | | | | | | | | deposition | |
| Example 1-41 | 3.2 | 20 | 0.8 | 1500 | 75 | 5.33 | 77 | 12 | Mild lithium | 82.1 |
| | | | | | | | | | deposition | |
| Example 1-42 | 3.2 | 20 | 0.8 | 1500 | 75 | 5.33 | 80 | 12 | Mild lithium | 83.4 |
| | | | | | | | | | deposition | |
| Example 1-43 | 3.2 | 20 | 0.8 | 1500 | 75 | 5.33 | 35 | 12 | Mild lithium | 76.2 |
| | | | | | | | | | deposition | |
| Example 1-44 | 3.2 | 20 | 0.8 | 1500 | 75 | 5.33 | 85 | 12 | Mild lithium | 73.1 |
| | | | | | | | | | deposition | |
| Example 1-45 | 3.2 | 20 | 0.8 | 1700 | 60 | 4.71 | 60 | 5 | Mild lithium | 77.2 |
| | | | | | | | | | deposition | |
| Example 1-46 | 3.2 | 20 | 0.8 | 1700 | 60 | 4.71 | 60 | 6 | Mild lithium | 78.1 |
| | | | | | | | | | deposition | |
| Example 1-47 | 3.2 | 20 | 0.8 | 1700 | 60 | 4.71 | 60 | 8 | No lithium | 81.2 |
| | | | | | | | | | deposition | |
| Example 1-48 | 3.2 | 20 | 0.8 | 1700 | 60 | 4.71 | 60 | 12 | No lithium | 82.3 |
| | | | | | | | | | deposition | |
| Example 1-49 | 3.2 | 20 | 0.8 | 1700 | 60 | 4.71 | 60 | 15 | No lithium | 83.4 |
| | | | | | | | | | deposition | |
| Example 1-50 | 3.2 | 20 | 0.8 | 1700 | 60 | 4.71 | 60 | 18 | Mild lithium | 79.1 |
| | | | | | | | | | deposition | |
| Example 1-51 | 3.2 | 20 | 0.8 | 1700 | 60 | 4.71 | 60 | 20 | Mild lithium | 78.5 |
| | | | | | | | | | deposition | |
| Example 1-52 | 3.2 | 20 | 0.8 | 1700 | 60 | 4.71 | 60 | 2 | Mild lithium | 76.2 |
| | | | | | | | | | deposition | |
| Example 1-53 | 3.2 | 20 | 0.8 | 1700 | 60 | 4.71 | 60 | 40 | Mild lithium | 75.1 |
| | | | | | | | | | deposition | |
| Comparative | / | 20 | 0.8 | 1500 | 75 | / | 12 | 12 | Moderate | 52.1 |
| Example 1 | | | | | | | | | lithium | |
| | | | | | | | | | deposition | |
| Comparative | 13.93 | 33.3 | 5.8 | 1500 | 75 | 5.33 | / | / | Severe lithium | 51.3 |
| Example 2 | | | | | | | | | deposition | |
| Comparative | 1.92 | 33.3 | 0.8 | 1500 | 75 | 5.33 | / | / | Severe lithium | 48.8 |
| Example 3 | | | | | | | | | deposition | |
| Comparative | / | 33.3 | 5.8 | 1500 | 75 | / | / | / | Severe lithium | 42.6 |
| Example 4 | | | | | | | | | deposition | |
| Comparative | 34.78 | 13.3 | 5.8 | 1500 | 75 | 5.33 | 40 | 88 | Severe lithium | 47.1 |
| Example 5 | | | | | | | | | deposition | |

Note:
“/” in Table 1 indicates no relevant preparation parameters.

From Examples 1-1 to 1-53 and Comparative Examples 1 to 5, it could be seen that by adjusting the mass percentage of the element Si in the first negative electrode material layer to be greater than the mass percentage of the element Si in the second negative electrode material layer, and providing stripes on the second negative electrode material layer, the degree of lithium deposition in the lithium-ion battery was mild, and the 600 cls capacity retention rate of the lithium-ion battery was improved. This indicated that the infiltration effect of the electrolyte on the negative electrode sheet of the present application was good, and the lithium-ion battery had good lithium deposition performance and cycling performance. In the lithium-ion battery in Comparative Example 1, no stripes was provided on the second negative electrode material layer. In the lithium-ion batteries in Comparative Examples 2 and 3, only one layer of negative electrode material layer was formed on each surface of the negative electrode current collector. In the lithium-ion battery in Comparative Example 4, only one layer of negative electrode material layer was formed on each surface of the negative electrode current collector, and no stripes were provided on the negative electrode material layer. In the lithium-ion battery of Comparative Example 5, the mass percentage of the element Si in the first negative electrode material layer was lower than the mass percentage of the element Si in the second negative electrode material layer. The degree of lithium deposition in the lithium-ion batteries of Comparative Examples 1 to 5 showed more severe and lower 600 cls capacity retention rates. In contrast, the degree of lithium deposition in the lithium-ion batteries of Examples 1-1 to 1-53 showed milder lithium deposition and higher 600 cls capacity retention rates, which indicated that the infiltration effect of the electrolyte on the negative electrode sheet was good, and the lithium-ion battery had better lithium deposition performance and cycling performance.

The value of W×C_{Si}×d/D usually affected the lithium deposition performance and cycling performance of the lithium-ion battery. From Examples 1-1 to 1-10, it could be seen that when the value of W×C_{Si}×d/D was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The thickness D of the second negative electrode material layer usually affected the lithium deposition performance and cycling performance of the lithium-ion battery. From Example 1-1 and Examples 1-11 to 1-20, it could be seen that when the thickness D of the second negative electrode material layer was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The mass percentage W of the element Si in the second negative electrode material layer usually affected the lithium deposition performance and cycling performance of the lithium-ion battery. From Example 1-14 and Examples 1-21 to 1-28, it could be seen that when the mass percentage W of the element Si in the second negative electrode material layer was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The specific capacity C_{Si} of the silicon-based material usually affected the lithium deposition performance and cycling performance of the lithium-ion battery. From Example 1-14 and Examples 1-29 to 1-36, it could be seen that when the specific capacity C_{Si} of the silicon-based material was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The thickness proportion T of the second negative electrode material layer usually affected the lithium deposition performance and cycling performance of the lithium-ion battery. From Example 1-1 and Examples 1-37 to 1-44, it could be seen that when the thickness proportion T of the second negative electrode material layer was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The mass percentage X of the element Si in the second negative electrode material layer based on the element Si in the negative electrode material layer usually affected the lithium deposition performance and cycling performance of the lithium-ion battery. From Examples 1-45 to 1-53, it could be seen that when the mass percentage X of the element Si in the second negative electrode material layer based on the element Si in the negative electrode material layer was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The depth d of a single stripe usually affected the lithium deposition performance and cycling performance of the lithium-ion battery. From Examples 1-1 to 1-53, it could be seen that when the depth d of a single stripe was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

TABLE 2

| | | Length | Length | Length | | | | | Capacity |
|---|---|---|---|---|---|---|---|---|---|
| | | proportion | proportion | proportion | | | | | retention |
| | | of first | of second | of third | | | | Degree of | rate after |
| | n | section | section | section | | | | lithium | 600 cls |
| | (μm) | (%) | (%) | (%) | a1 | a2 | a3 | deposition | (%) |
| Example | 65 | 30 | 40 | 30 | 2 | 5 | 3 | No lithium | 85.5 |
| 1-1 | | | | | | | | deposition | |
| Example | 45 | 30 | 40 | 30 | 2 | 5 | 3 | Mild | 84.2 |
| 2-1 | | | | | | | | lithium | |
| | | | | | | | | deposition | |
| Example | 85 | 30 | 40 | 30 | 2 | 5 | 3 | Mild | 86.2 |
| 2-2 | | | | | | | | lithium | |
| | | | | | | | | deposition | |
| Example | 35 | 30 | 40 | 30 | 2 | 5 | 3 | Mild | 83.2 |
| 2-3 | | | | | | | | lithium | |
| | | | | | | | | deposition | |
| Example | 95 | 30 | 40 | 30 | 2 | 5 | 3 | Mild | 81.2 |
| 2-4 | | | | | | | | lithium | |
| | | | | | | | | deposition | |
| Example | 65 | 30 | 40 | 30 | 1 | 4 | 2 | Mild | 82.2 |
| 2-5 | | | | | | | | lithium | |
| | | | | | | | | deposition | |
| Example | 65 | 30 | 40 | 30 | 3 | 6 | 4 | No lithium | 86.2 |
| 2-6 | | | | | | | | deposition | |
| Example | 65 | 10 | 80 | 10 | 2 | 5 | 3 | Mild | 83.2 |
| 2-7 | | | | | | | | lithium | |
| | | | | | | | | deposition | |
| Example | 65 | 20 | 60 | 20 | 2 | 5 | 3 | Mild | 83.8 |
| 2-8 | | | | | | | | lithium | |
| | | | | | | | | deposition | |

The width n of a single stripe usually affected the lithium deposition performance and cycling performance of the lithium-ion battery. From Example 1-1 and Examples 2-1 to 2-4, it could be seen that when the width n of a single stripe was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The number of stripes on the second negative electrode material layer per 2 cm in each section, that is, the values of a1, a2, and a3, usually affected the lithium deposition performance and cycling performance of the lithium-ion battery. From Example 1-1 and Examples 2-5 to 2-6, it could be seen that when the number of stripes on the second negative electrode material layer per 2 cm in each section, that is, the values of a1, a2, and a3, was within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

The length proportions of the first section, second section, and third section usually affect the lithium deposition performance and cycling performance of the lithium-ion battery. From Example 1-1 and Examples 2-7 to 2-8, it could be seen that when the length proportions of the first section, second section, and third section are within the scope of the present application, the degree of lithium deposition in the lithium-ion battery was mild, and the 600 cls capacity retention rate was high, which indicated that the infiltration effect of the electrolyte on the negative electrode sheet in some embodiments of the present application was good, and the lithium-ion battery had favorable lithium deposition performance and cycling performance.

It should be noted that, in this context, relational terms such as first and second are used merely to distinguish one entity or operation from another entity or operation, and do not necessarily require or imply any such actual relationship or sequence between these entities or operations. Moreover, the terms “include,” “comprising,” or any other variant thereof are intended to cover a non-exclusive inclusion, such that a process, method, or article that includes a series of elements includes not only those elements but also other elements not expressly listed or inherent to such process, method, or article.

The various embodiments in this specification are described in a related manner, and identical or similar parts between the various embodiments may be referred to each other, with each embodiment focusing on differences from other embodiments.

The above descriptions are merely preferred embodiments of the present application and are not intended to limit the present application. Any modifications, equivalent substitutions, improvements, or the like made within the spirit and principles of the present application shall be included within the protection scope of the present application.

What is claimed is:

1. A cylindrical secondary battery, comprising a negative electrode sheet, wherein the negative electrode sheet comprises a negative electrode current collector and a negative electrode material layer disposed on at least one surface of the negative electrode current collector, and the negative electrode material layer comprises a first negative electrode material layer and a second negative electrode material layer;
the first negative electrode material layer is located between the negative electrode current collector and the second negative electrode material layer, the first negative electrode material layer and the second negative electrode material layer each comprise a silicon-based material, and based on a mass of the negative electrode material layer, a mass percentage of element Si in the first negative electrode material layer is greater than a mass percentage of element Si in the second negative electrode material layer; and
the second negative electrode material layer is provided with a plurality of stripes, the plurality of stripes extend along a width direction of the unfolded negative electrode sheet, and the plurality of stripes are spaced apart along a length direction of the unfolded negative electrode sheet.

2. The cylindrical secondary battery according to claim 1, wherein along a thickness direction of the negative electrode sheet, a thickness of the second negative electrode material layer is D μm, and a depth of a single stripe is d μm; and
based on a mass of the second negative electrode material layer, a mass percentage of the element Si in the second negative electrode material layer is W, and a specific capacity of the silicon-based material is C_{Si} mAh/g, 1.01≤W×C_{Si}×d/D≤15.87, 10≤D≤55, 0.6%≤W≤5%, and 1300≤C_{Si}≤1800.

3. The cylindrical secondary battery according to claim 2, wherein 3.20≤W×C_{Si}×d/D≤4.76.

4. The cylindrical secondary battery according to claim 1, wherein along the length direction of the unfolded negative electrode sheet, the second negative electrode material layer comprises a first section, a second section, and a third section connected in sequence; wherein
based on a length of the second negative electrode material layer, a length proportion of the first section is 10% to 30%, a length proportion of the second section is 40% to 80%, and a length proportion of the third section is 10% to 30%; and
the stripes on the first section have a first density, the stripes on the second section have a second density, the stripes on the third section have a third density, the second density is greater than the first density, and the third density is less than or equal to the second density.

5. The cylindrical secondary battery according to claim 4, wherein in the first section, the number of stripes on the second negative electrode material layer per 2 cm is 1 to 3; in the second section, the number of stripes on the second negative electrode material layer per 2 cm is 4 to 6; and in the third section, the number of stripes on the second negative electrode material layer per 2 cm is 2 to 4.

6. The cylindrical secondary battery according to claim 1, wherein along the length direction of the unfolded negative electrode sheet, a width of a single stripe is n μm, and 45≤n≤85.

7. The cylindrical secondary battery according to claim 1, wherein along the thickness direction of the negative electrode sheet, a depth of a single stripe is d μm, and 1≤d≤30.

8. The cylindrical secondary battery according to claim 1, wherein along the thickness direction of the negative electrode sheet, a thickness of the second negative electrode material layer is D μm, and 12≤D≤45.

9. The cylindrical secondary battery according to claim 1, wherein based on a mass of the second negative electrode material layer, a mass percentage of the element Si in the second negative electrode material layer is W, and 1%≤W≤2%.

10. The cylindrical secondary battery according to claim 1, wherein a specific capacity of the silicon-based material is C_{Si} mAh/g, and 1400≤C_{Si}≤1600.

11. The cylindrical secondary battery according to claim 1, wherein based on a thickness of the negative electrode material layer, a thickness proportion of the second negative electrode material layer is T, and 40%≤T≤80%.

12. The cylindrical secondary battery according to claim 11, wherein 50%≤T≤75%.

13. The cylindrical secondary battery according to claim 1, wherein based on a mass of element Si in the negative electrode material layer, the mass percentage of the element Si in the second negative electrode material layer is X, and 5%≤X≤20%.

14. The cylindrical secondary battery according to claim 13, wherein 8%≤X≤15%.

15. An electronic device, comprising a cylindrical secondary battery, the cylindrical secondary battery, comprising a negative electrode sheet, wherein the negative electrode sheet comprises a negative electrode current collector and a negative electrode material layer disposed on at least one surface of the negative electrode current collector, and the negative electrode material layer comprises a first negative electrode material layer and a second negative electrode material layer;
the first negative electrode material layer is located between the negative electrode current collector and the second negative electrode material layer, the first negative electrode material layer and the second negative electrode material layer each comprise a silicon-based material, and based on a mass of the negative electrode material layer, a mass percentage of element Si in the first negative electrode material layer is greater than a mass percentage of element Si in the second negative electrode material layer; and
the second negative electrode material layer is provided with a plurality of stripes, the plurality of stripes extend along a width direction of the unfolded negative electrode sheet, and the plurality of stripes are spaced apart along a length direction of the unfolded negative electrode sheet.

16. The electronic device battery according to claim 15, wherein along a thickness direction of the negative electrode sheet, a thickness of the second negative electrode material layer is D μm, and a depth of a single stripe is d μm; and
based on a mass of the second negative electrode material layer, a mass percentage of the element Si in the second negative electrode material layer is W, and a specific capacity of the silicon-based material is C_{Si} mAh/g, 1.01≤W×C_{Si}×d/D≤15.87, 10≤D≤55, 0.6%≤W≤5%, and 1300≤C_{Si}≤1800.

17. The electronic device according to claim 16, wherein 3.20≤W×C_{Si}×d/D≤4.76.

18. The electronic device according to claim 15, wherein along the length direction of the unfolded negative electrode sheet, the second negative electrode material layer comprises a first section, a second section, and a third section connected in sequence; wherein
based on a length of the second negative electrode material layer, a length proportion of the first section is 10% to 30%, a length proportion of the second section is 40% to 80%, and a length proportion of the third section is 10% to 30%; and
the stripes on the first section have a first density, the stripes on the second section have a second density, the stripes on the third section have a third density, the second density is greater than the first density, and the third density is less than or equal to the second density.

19. The electronic device according to claim 18, wherein in the first section, the number of stripes on the second negative electrode material layer per 2 cm is 1 to 3; in the second section, the number of stripes on the second negative electrode material layer per 2 cm is 4 to 6; and in the third section, the number of stripes on the second negative electrode material layer per 2 cm is 2 to 4.

20. The electronic device according to claim 15, wherein along the length direction of the unfolded negative electrode sheet, a width of a single stripe is n μm, and 45≤n≤85.
